(19) United States
(12) Patent Application Publication
(10) Pub. No.: US 2010/0295870 A1
(43) Pub. Date: Nov. 25, 2010

(54) MULTI-SOURCE MEDICAL IMAGING SYSTEM

(76) Inventors: Amir Baghdadi, Gilroy, CA (US); Jerome Truppa, Magalia, CA (US); Chad C. Chang, Fremont, CA (US); Gary J. Duggan, Morgan Hill, CA (US); Babak Saghafi, Santa Clara, CA (US); Alexander Pilgun, Castro Valley, CA (US); Chung-Ying Huang, San Jose, CA (US); Yiying Fan, San Jose, CA (US); Michael Thai, San Jose, CA (US); Jonah Post, Campbell, CA (US); Ronald Hansen, San Jose, CA (US)

Correspondence Address: SHAY GLENN LLP, 2755 CAMPUS DRIVE, SUITE 210, SAN MATEO, CA, 94403, US

(21) Appl. No.: 12/786,353

(22) Filed: May 24, 2010

Related U.S. Application Data
(60) Provisional application No. 61/180,808, filed on May 22, 2009.
(60) Provisional application No. 61/251,201, filed on Oct. 13, 2009.

(51) Int. Cl. G09G 5/00

(52) U.S. Cl. 345/650

(57) ABSTRACT

This invention related to a clinical connectivity device coupled to a display. The clinical connectivity device comprises a user interface configured to select a display format; a controller configured to receive commands from the user interface and for controlling operation of the clinical connectivity device; and a selector coupled to the controller and an adjuster. The selector is configured to receive input signals of graphics, image, video, audio or data from devices in a clinical setting and is further configured to select a signal to be transmitted to an adjuster based on the input signal format. The adjuster is coupled to the controller and the display for matching the received signal format to the display format. The adjuster comprises a temporal combiner configured to combine synchronous and asynchronous received signals; a spatial combiner configured to place graphics, image, video or data; a scaler for geometric scaling and non-geometric scaling of graphics, image, video or data; and a rotation component configured to rotate graphics, image, video or data.

### CROSS REFERENCE TO RELATED APPLICATIONS

This application claims priority to U.S. Provisional Patent Application No. 61/180,808 (filed May 22, 2009) entitled, “MULTI-SOURCE MEDICAL IMAGING SYSTEM” and U.S. Provisional Patent Application No. 61/251,201 (filed Oct. 13, 2009) entitled, “MULTI-SOURCE MEDICAL IMAGING SYSTEM.”

### INCORPORATION BY REFERENCE

The subject matter of the present application is related to subject matter described in U.S. patent application Ser. No. 11/715,711 (filed Oct. 7, 2007) entitled, “WIDE VIEW DISPLAY SYSTEM FOR MEDICAL SURGICAL APPLICATIONS,” which are incorporated herein by reference. All publications and patent applications mentioned in this specification are herein incorporated by reference to the same extent as if each individual publication or patent application was specifically and individually indicated to be incorporated by reference.

### FIELD OF THE INVENTION

The present invention relates generally to imaging devices used in medicine as well as hospitals and clinics.

### BACKGROUND OF THE INVENTION

Video signals are typically routed to boom-mounted surgical displays using several sets of long video cables. In addition, the type of cable required is dependant on the source of the video. Typically, eight or more various video cables up to 100 feet in length may be connected to a display. This traditional signal routing mechanism causes clutter in small areas of a clinical or hospital setting. Because of cable length restrictions and limited area requirements, there is a need to reduce the number of long cables while maintaining video, image and telesurgery delivery to displays.

### SUMMARY OF THE INVENTION

One aspect of the invention includes a multifunctional device that offers a complete video switching, video combining, image streaming and digital capture solution for surgical carts and/or integrated operating rooms (OR). This device offers connectivity between medical professionals by enabling real-time interactive consultation across rooms or continents. This device allows video and imaging signal control for surgical and interventional suites. Centralized DC power and fiber-based video delivery for displays makes OR installations using the device feasible in a hospital environment. The device brings video integration and distribution benefits to small and large surgical environments.

In particular, the video connectivity device is a video informatics platform product. The device features full high-definition (HD) video scaling and switching, full HD video streaming, and touch screen interface. Some features include full HD video scaling and switching, full HD video streaming, touch screen user interface, RS-232 command interface, USB host connector and an Ethernet interface.

The video connectivity device is configured to display simultaneous outputs which may be of different formats. Any input can be directed—uniquely and/or simultaneously—to any output. In particular, the video connectivity device is configured to display three primary outputs and three secondary outputs or any combination thereof. A primary output may be a main image on a display and the secondary output may be a corner image on a display. The primary and the secondary images may also be displayed simultaneously, i.e., side by side.

The video connectivity device can combine all input modalities and present them to a display that matches the resolution and attributes of the connectivity device output. The video connectivity device includes dual DVI and HD-SDI inputs as well as full multi-modality input combination flexibility. This embodiment allows any input to be viewed with any other input in a split-screen or Picture In Picture (PIP) configuration. In addition, the video connectivity device may be equipped with HD video streaming capabilities.

One embodiment of the video connectivity device includes a normalizer in connection with a controller and display. The normalizer comprises input connectors that receive input signals from an input interface. The normalizer further comprises selector(s) and an adjuster. The input signals may be transmitted individually or together. The input signals that are compatible with the input connectors are then transmitted to selector(s) to select a format of signal to be transmitted to the adjuster. The selectors select one input and deliver it to the adjustor. Multiple selectors are required to handle different signal types, e.g., analog signal versus digital signal, Luminance-Chrominance (YUV) signal versus Red Green Blue (RGB) signal, differential signal versus single-ended signal. The selector(s) are coupled to the controller for receiving commands from the display. The commands pertain to the display format requirements or operation of the video connectivity device. The selector(s) then send electrical signals to the adjuster. The selector(s) may be multiplexers.

The adjuster is coupled to the controller and the display for matching the received signal format to the display format. Examples of formatting may be refresh rate, resolution and color attributes. The adjuster comprises a temporal combiner for synchronous or asynchronous combining of received signals, a spatial combiner for placement of graphics, image, video or data, a scaler for geometric scaling or non-geometric scaling of graphics, image, video or data and a rotation component for graphics, video or image. The temporal combiner combines received synchronous or asynchronous signals of graphics, image, video, audio or data. The graphics, image, video, audio or data may then be synchronized for transmission simultaneously or in a particular pattern. The temporal combining may occur in near real time or real time. The spatial combiner places input signals together for proper configuration of graphics, image, video or data. The scaler scales the graphics, image, video or and data for geometric scaling or non-geometric scaling. Geometric or non-geometric scaling enlarges or decreases the size of the graphics, image, video or data. The adjuster also rotates graphics, image and video for proper configuration on the display.

Another embodiment of the video connectivity device includes Adjuster 1, adjuster 2, adjuster 3, adjuster 4 and a selector that are part of the normalizer. The video connectivity device comprises video inputs which may be permanent or modular/replaceable. The video inputs send input data and deliver the input data to a selector which may be a switch. The selector receives input data and delivers the input data to an adjuster (adjuster 1, adjuster 2, adjuster 3, and adjuster 4) in accordance to the display 1, 2, 3 and 3′. The selector switch may be configured to receive eight inputs and to send six outputs. The adjusters receive the input signals and transmit them to a backplane connecting to a controller. The controller controls the functionality of the received signals and delivers them through the backplane to the output modules 1, 2, 3 and 3′. The signal of graphics, image, video, audio or data are then transmitted through the output module 1, 2, 3, and 3′ to the display selected.

A user may input that they wish to preview an image, graphic, video, audio or data. The input may be sent by the controller to the adjuster. The selector may receive the input signal and transmit the signal to adjuster. The adjuster may then adjust the preview signal to a preview display.

Another embodiment of the video connectivity device includes a controller. The controller determines which input channel signal is to be transmitted to the backplane connector or the normalizer. The controller is configured to send and receive data from the normalizer. The controller includes an operating component (e.g., Field Programmable Gate Array (FPGA)) configured to transmit information processed in the controller and to receive information for processing in the controller. The controller comprises an interlacer (and a de-interlacer) for interlacing (and de-interlacing) video, graphics, image and data. A microcontroller controls the controller and communicates via RS 232 interface to a touch screen. Audio in and audio out streaming data may be sent to the audio port and then to a coder-encoder (codec) for processing in the controller. USB connectivity to the hard drive is also available through the controller. For remote connectivity, data can be sent from the ethernet port (i.e., RJ45) to the Ethernet switch and then to a codec. Data from the matrix cross switch is transmitted to the Codec block for encoding data in the controller. Also, in the controller, data is decoded in the Codec block for transmittal to the matrix cross switch.

The general operation of the video connectivity device is provided as follows. In operation, the normalizer receives input signals of video, graphics, images, audio and data in various formats. The inputs may be received in real-time. The input may be sent to a decoder, a deserializer, a filter, a buffer and/or an analog to digital converter (A/D converter). In particular, the inputs may be converted into one or more types of analog signal formats. If the signal is in an analog format, the signal may then be converted into a digital signal. Analog input signals may be converted into one type of analog format before being transmitted to the Analog to Digital Converter. The digital format may be converted into a common color based digital format. The digital signal may then be combined, scaled, spatialized, rotated and synchronized to be matched to the display format.

Details of these embodiments are described below.

### BRIEF DESCRIPTION OF THE DRAWINGS

FIG. 1 illustrates one embodiment of a system for video distribution and telemedicine connectivity supported by the video connectivity device.

FIG. 2 illustrates one embodiment of the video connectivity device coupled to a networking system such as a hospital network.

FIG. 3 shows an exemplary general diagram of the video connectivity device coupled to a remote interface and a display.

FIG. 4 shows one example of a normalizer in connection with a controller and display.

FIGS. 5A and 5B illustrate a detailed example of a normalizer in connection with the display.

FIG. 6 provides a flow chart of one functionality of the controller where multiple video connectivity devices need to be utilized for outputs to multiple displays.

FIG. 7 illustrates an image and a video of different sizes and formats that may be combined for presentation on a display using a video connectivity device.

FIG. 8 shows a general diagram of the video connectivity device coupled to a remote interface and three displays.

FIG. 9 illustrates exemplary components of the video connectivity device with an adjuster 1, adjuster 2, adjuster 3, adjuster 4 and a selector as a part of a normalizer.

FIG. 10 illustrates a detailed example of a normalizer.

FIG. 11 illustrates a detailed example of a controller.

FIG. 12 illustrates examples of output modules.

FIG. 13 illustrates examples of input modules.

### DETAILED DESCRIPTION OF THE INVENTION

One aspect of the invention relates to a video connectivity device for integrated operating rooms (ORs). The video connectivity device provides compliancy with ORs, hospitals and/or clinical settings, video control applications and control systems. The video connectivity device enables multi-modality imaging, integrating images from pathology, PACS imaging, fluoroscopy and ultrasound with surgical video. The video connectivity device further enables extended clinical reach and medical documentation. The video connectivity device is coupled to multiple displays (e.g., 23″ Radiance® surgical displays). Alternatively, multiple video connectivity devices may be coupled to one display.

An aspect of the invention is a video connectivity device that transmits output to multiple displays. The video connectivity device is a system intended for installation on surgical carts.

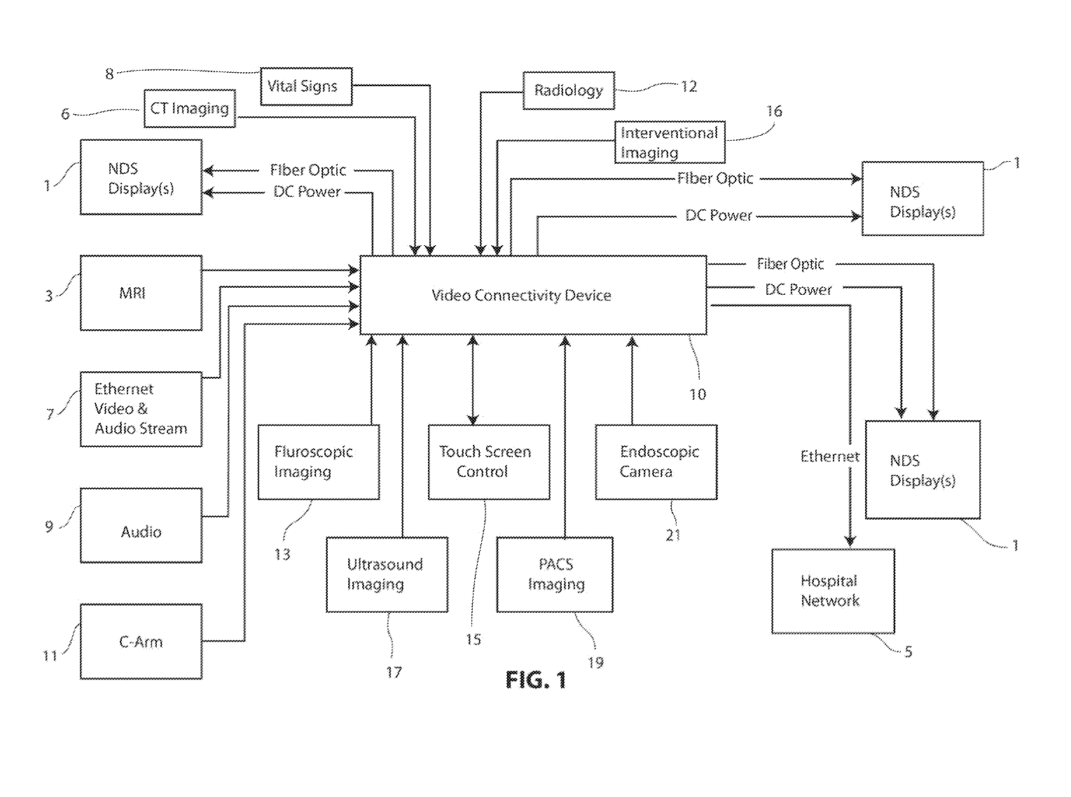

FIG. 1 illustrates one embodiment of a system for video distribution and telemedicine connectivity supported by the video connectivity device. In this embodiment, the video connectivity device 10 is coupled to a networking system such as a hospital network 5 via an Ethernet hub. The video connectivity device is coupled to multiple display(s) 1 via fiber optic cables to distribute video, graphics, images, audio and medical data and to operate in telemedicine. The video connectivity device may also provide DC power to the display(s) 1.

Multiple modalities are supported by the video connectivity device. Modalities supported by the video connectivity device may include magnetic resonance imaging (MRI) 3, interventional imaging systems 16 (OR/interventional digital imaging control center), radiology based systems 12, PACS 19, computer tomography (CT) imaging 6, fluoroscopic imaging 13 (i.e., c-arm imaging 11), ultrasound imaging 17, endoscopic imaging 21, audio system 9, ethernet video and audio stream 7, touch screen control 15 and vital signs monitoring systems 8. Other modalities may also be supported. The modalities may be in the following formats (although the modalities are not limited to the following formats): Digital Video Interface (DVI), High Definition—Serial Digital Interface (HD-SDI), Serial Digital Interface (SDI), High Definition Red Green Blue Composite Sync (HD-RGBS), Red Green Blue Composite Sync (RGBS), High Definition Luma-Chroma (HD-YPbPr), Luma-Chroma (YPbPr), Video Graphics Array (VGA), Sync-On-Green (SOG), S-Video and Composite Video. Audio streaming is also available to support the displays.

The video connectivity device 10 also provides IP network server access as well as video and audio via local area network (LAN)/internet. A recording station may be coupled to a LAN to record video footage on a standard PC or another machine. Multiple users can access the video/audio stream simultaneously via the Ethernet connection.

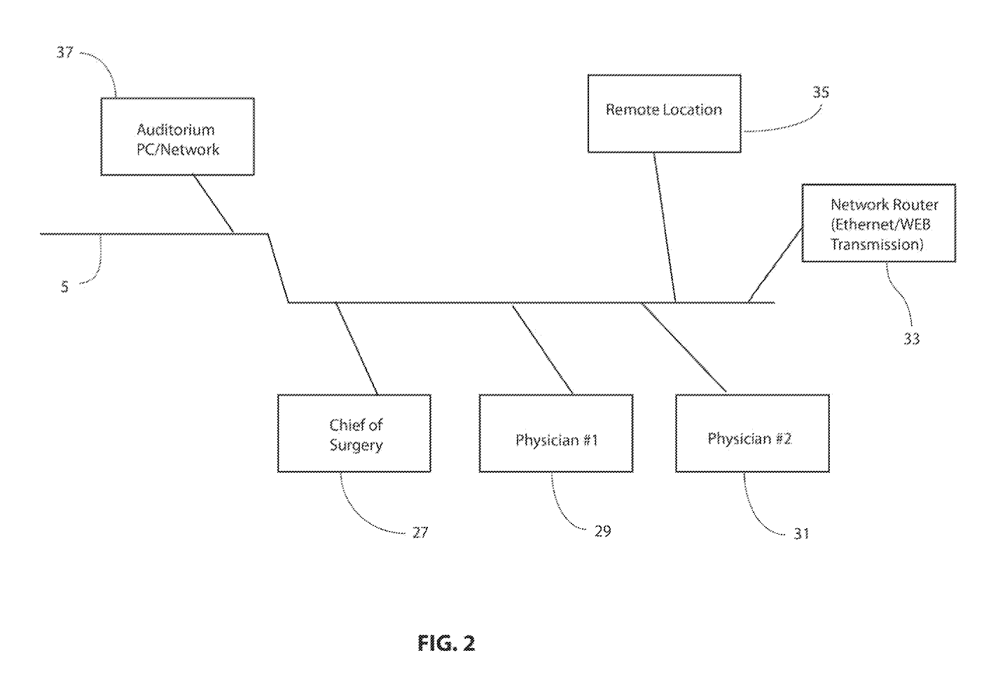

FIG. 2 illustrates another embodiment of the video connectivity device 10 coupled to a networking system such as a hospital network 5. The networking system may be associated with a station for chief of surgery 27 and at least one clinician 29 and 31. These clinicians may be able to view images or video by means of the video connectivity device. The networking system may be associated with a separate network such as an auditorium network 37 for viewing of images or video by means of the video connectivity device. The network 5 may be connected to a remote location 35 and network router 33 via Ethernet/web transmission.

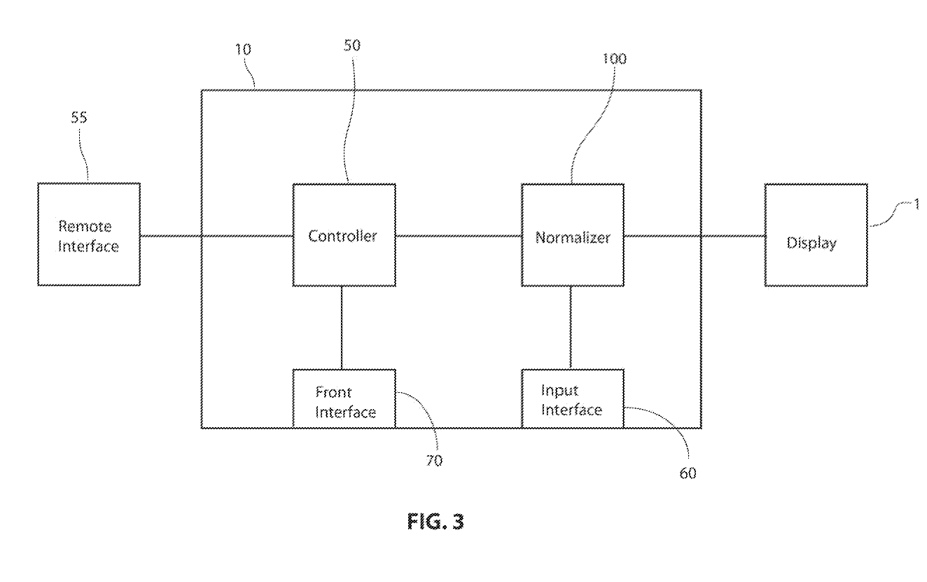

FIGS. 3-7 illustrate one embodiment of the video connectivity device 10.

FIG. 3 shows an exemplary general diagram of the video connectivity device 10 coupled to a remote interface 55 and a display 1. The remote interface 55 allows a user to input commands for controlling operation of the video connectivity device 10 and may be optional. The video connectivity device includes a controller 50 and a normalizer 100. Each connectivity device is coupled to a display 1 with a fiber optic cable. The output supplied by the fiber optic cable has a similar format as the display format attributable to the controller 50 functionality. Examples of formatting may be refresh rate, resolution and color attributes. The controller 50 has a front interface 70 for user selection of a modality and thus allowing a user to input commands for controlling operation of the video connectivity device 10. The normalizer 100 has an input interface 60 for interconnection of signaling from the modalities. The remote interface 55 and front interface 70 may be in the form of front panel buttons or a user interface (i.e., touch screen interface) coupled to the video connectivity device 10. The input interface 60 of the video connectivity device 10 may include a DVI input, HD-SDI Loop-back in, HD-SDI Loop-back out, HD-SDI Input (Ch. 2), HD-SDI Input (Ch. 1), Red Green Blue (RGB)/Luma-Chroma(YPbPr)/VGA, HD-YPbPr/YPbPr, VGA input, Sync-On-Green, S-Video input, Composite Video input as well as S-video output, Ethernet stream output, VGA output and Fiber Optic Output. Other video, image, audio inputs and outputs may be included in the video connectivity device.

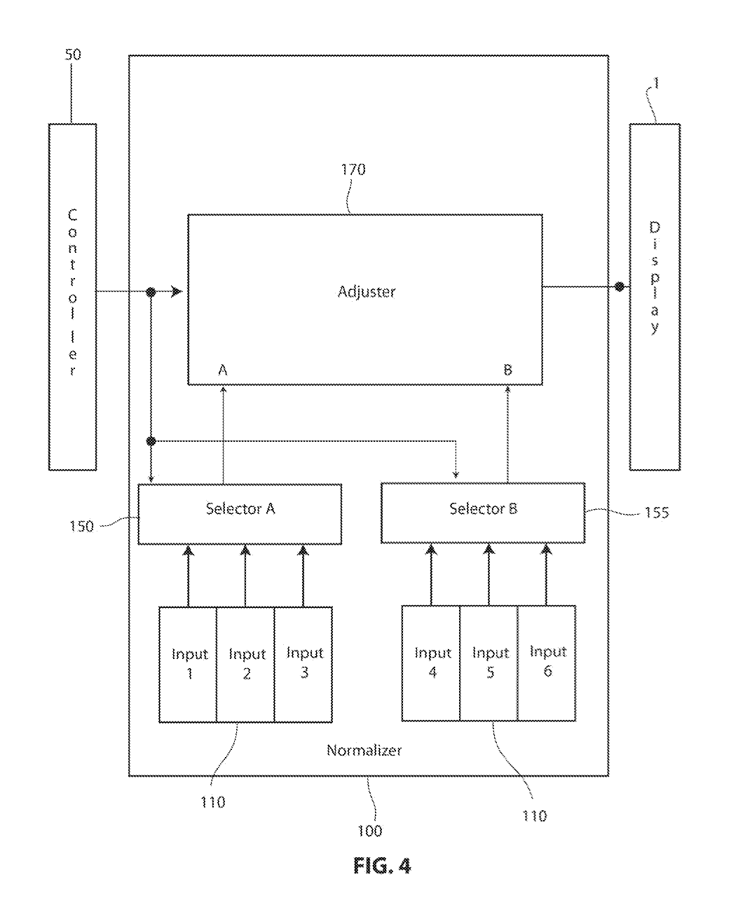

FIG. 4 shows one example of a normalize 100 in connection with the controller 60 and display 1. The normalizer comprises input connectors that receive input signals from the input interface 60. The normalizer further comprises selector 150 and 155 and adjuster 170. The input signals may be transmitted individually or together. The input signals that are compatible with the input connectors are then transmitted to selectors 150 and 155 to select a format of signal to be transmitted to the adjuster 170. The selectors 150 and 155 select one input and delivers it to the adjustor 170. Multiple selectors (e.g., 150 and 155) are required to handle different signal types, e.g., analog signal versus digital signal, Luminance-Bandwidth-Chrominance (YUV) signal versus RGB signal, differential signal versus single-ended signal. The selectors 150 and 155 are coupled to the controller 50 for receiving commands from the display 1. The commands pertain to the display format requirements or operation of the video connectivity device 10. The selectors 150 and 155 then send the electrical signals to the adjuster 170. The selectors 150 and 155 may be multiplexers.

The adjuster 170 is coupled to the controller 50 and the display 1 for matching the received signal format to the display format. The adjuster comprises a temporal combiner for synchronous or asynchronous combining of received signals, a spatial combiner for placement of graphics, image, video or data; and a scaler for geometric scaling or non-geometric scaling and rotation of graphics, video, image or data. The temporal combiner combines received synchronous and asynchronous signals of graphics, image, video, audio or data. The graphics, image, video, audio or data may then be synchronized for transmission simultaneously or in a particular pattern. The temporal combining may occur in near real time or real time. The spatial combiner places input signals together for proper configuration of graphics, image, video, audio or data. The scaler scales the graphics, image, video, audio or and data for geometric scaling or non-geometric scaling. Geometric and non-geometric scaling enlarges or decreases the size of the graphics, image, video or data. The adjuster 170 also rotates graphics, image, video and data for proper configuration on the display 1.

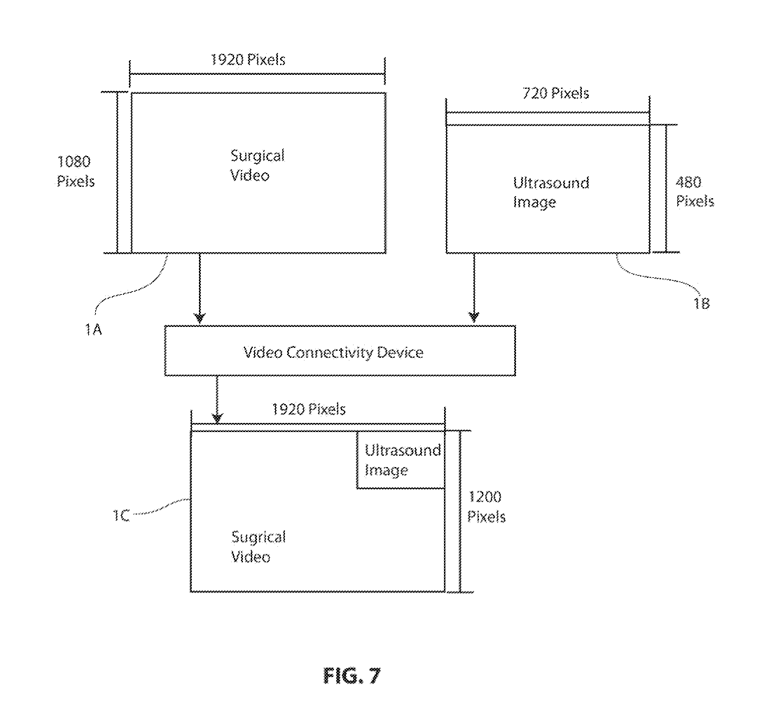

The general operation of the video connectivity device 10 is provided as follows. In operation, the normalizer 100 receives input signals of video, graphics, images, audio and data in various formats. The inputs may be received in real-time. The inputs may then be converted into one or more types of analog signal formats. In particular, analog input signals may be converted into one type of analog format before being transmitted to an Analog to Digital Converter. If the signal is in an analog format, the signal may then be converted into a digital signal. The digital format may be converted into one common color based digital format. The digital signal may then be combined, scaled and synchronized to be matched to the display format. For example, FIG. 7 illustrates images/video of various sizes and formats that may be combined for presentation on a display using a video connectivity device. In FIG. 7, the user selected input (or multi-modality input combination) may be processed in real-time, and converted to a digital video format that matches the native resolution of a surgical display (1920×1200 or 1080p).

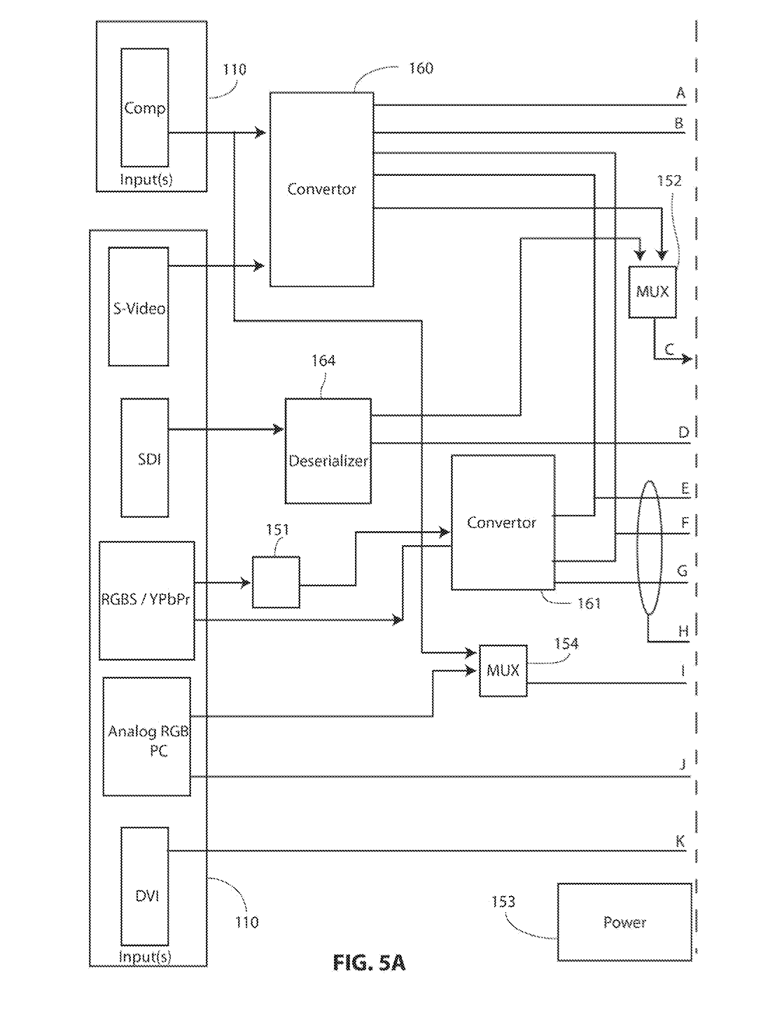

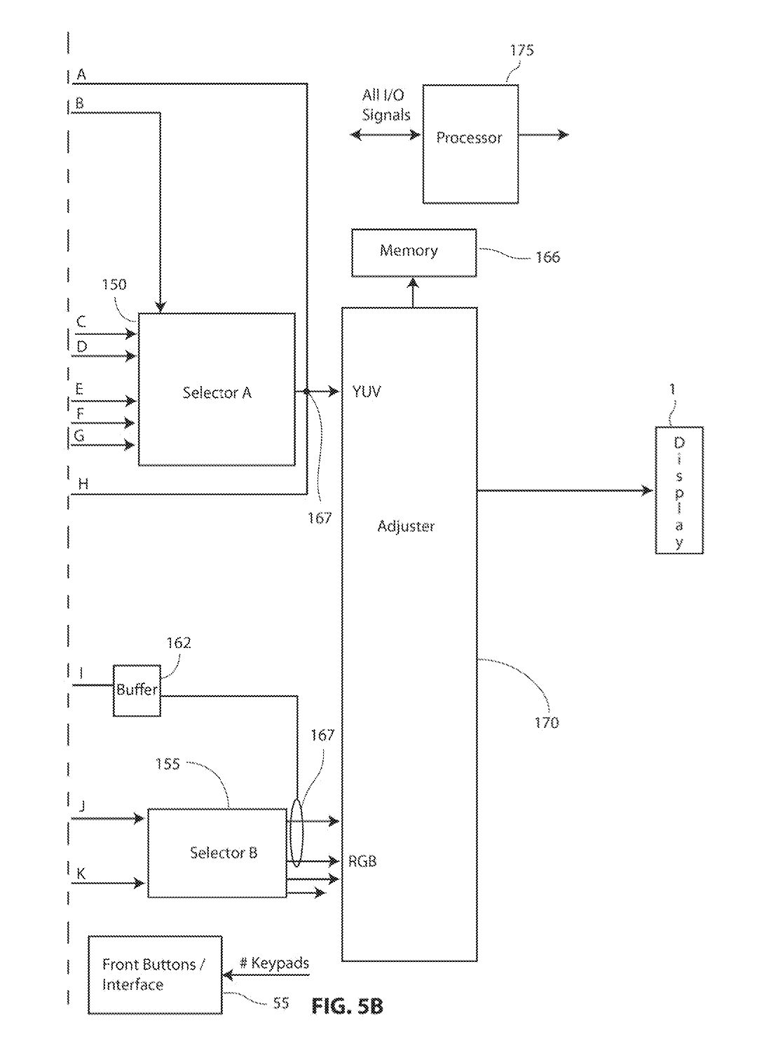

FIGS. 5A and 5B illustrate an example of a normalizer 100 in connection with the display 1. The arrows indicate direction of signaling from one component to another. Generally, the normalizer 100 combines, scales, spatializes, synchronizes and rotates the multiple modality inputs for output to the display 1. In FIGS. 5A and 5B, input signals may be received in various formats as mentioned above. The input signals may then be sent to a decoder, a deserializer, a filter, a buffer and/or an analog to digital converter (A/D converter). A switch or a plurality of switches may be utilized to aid in the transmission. Analog signals may then be converted into a digital format using an A/D converter (e.g., SA7118 or AD 9883). The digital format may be a RGB or a YUV format. The digital format may be converted into one common color based digital format using selector A in FIG. 5B. The digital signal may then be transmitted to the adjuster 170 to match the resolution and other attributes of the display. The adjuster 170 is used to display graphics, image, video or data to the display 1.

For example, the input signal may be a composite video signal. The composite video signal and s-video signal may then be sent to a converter 160 (e.g., 8 bit converter). The composite video signal may also be sent to a multiplexer 154 (e.g., SOG/RGB Mux) for selection of signals. An SDI signal may be sent to a deserializer 164 for digital to digital conversion. A RGBS/YPbPr signal may be sent to a filter selector and a multiplexer 151 and then to a converter 161. An analog RGB signal from a PC may be sent to the multiplexer 154 or to the selector B 155. The DVI input signal may then be sent to the selector 155. The signal from the converter 160 may then bypass selector A 150 and be transmitted to adjuster 170. The signal from converter 160 may also be sent to another converter 161 (e.g., analog to digital converter) or to a multiplexer 152. The multiplexer 152 may then send a signal to selector A 150. The composite signal may also be sent to multiplexer 154 which is then transmitted to a buffer 162. The signal from the deserializer may be sent to multiplexer 152. The signal from the deserializer may also be sent to selector A 150. The converter 161 may then send the signal to selector A 150. The signal from the converter 161 may bypass the selector A 150 and be sent to adjuster 170. Signals from the buffer 162 and selector B 155 are then received by the adjuster. The signals from the buffer 162 and selector B 155 may be received from in a RGB format. The signals from the converter 160, selector A 150 and converter 162 are received at tri-state output 167 and sent to the adjuster 170. The signals at the tri-state output 167 may be received in a YUV format. Memory 166 is used to storage by the adjuster 170 for combining, scaling, spatializing, rotating and synchronizing.

For multiple displays, multiple adjusters may be utilized. Alternatively, the combiner/synchronizer/scalar may be separated into individual components. The combined, scaled and/or synchronized signal may then transmit to a specific connector element for output to a display or to a LCD screen. As shown in FIGS. 5A and 5B, processors, memory, switches, regulators and other elements may be added to the scalar board to enable video, image or data output signals to be transmitted to the display.

The controller 50 is coupled to interfaces 55, 70 and the normalizer 100. The controller 50 determines which input channel signal is to be transmitted to the scalar board. The controller 50 may receive selection and control commands from interfaces 55, 60, 70 and decode the control commands. Based on the command, one or more of the video inputs to the scalar board will be directed to the display. The controller 50 responds to the interfaces 55, 70 (i.e., front panel buttons or user touch screen interface) to control functionality of the video connectivity device 10.

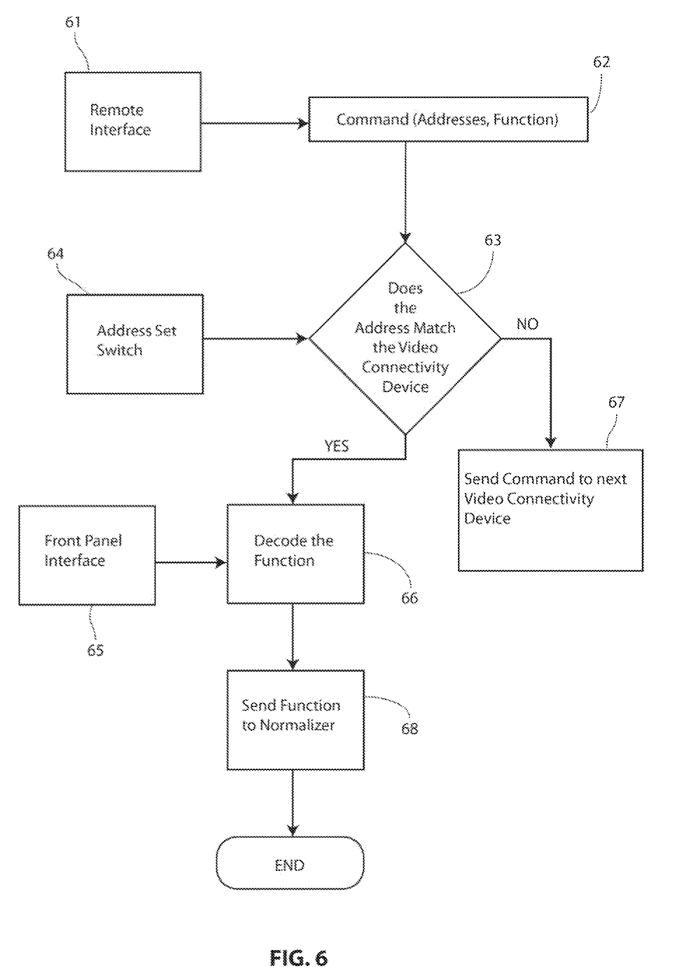

FIG. 6 provides a flow chart of one functionality of the controller 50 where multiple video connectivity devices need to be utilized for outputs to multiple displays. A user provides a command via a remote interface (e.g., user touch screen interface). The command contains an address or addresses along with a function signal. The controller 50 then determines whether the address matches the video connectivity device 10. If the address matches the video connectivity device 10, the function is decoded and an input signal is transmitted to the normalizer 100. If the address does not match the video connectivity device 10, the command is transmitted to the next video connectivity device 10. Alternatively, the user may accomplish input selection via the front panel interface on the video connectivity device 10 which will decode the function on the video connectivity device 10.

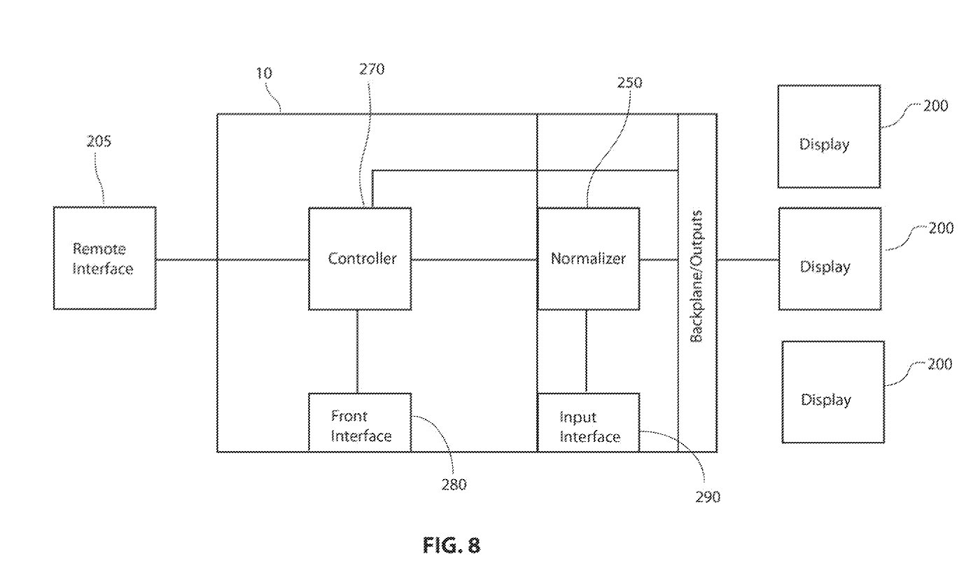

Next, FIGS. 8-13 illustrate another embodiment of the video connectivity device 10. The video connectivity device 10 may have a power switch and a touch screen interface. The input and output interfaces may include DVI (Digital Visual Interface), SDI (Serial Digital Interface, including HD and 3G), RS232, YPbPr, S-Video, optical and fiber, audio, SPDIF (Sony/Philips Digital Interconnect Format), Ethernet, USB (Universal Serial Bus), VGA, Composite, and SOG (Sync-on-Green). Duplicate inputs and outputs such as HD-SDI Loop-back out, HD-SDI Input (Ch. 2), HD-SDI Input (Ch. 1), RGB/YPbPr/VGA, HD-YPbPr/YPbPr, VGA input, Sync-On-Green and Fiber Optic Output may be included.

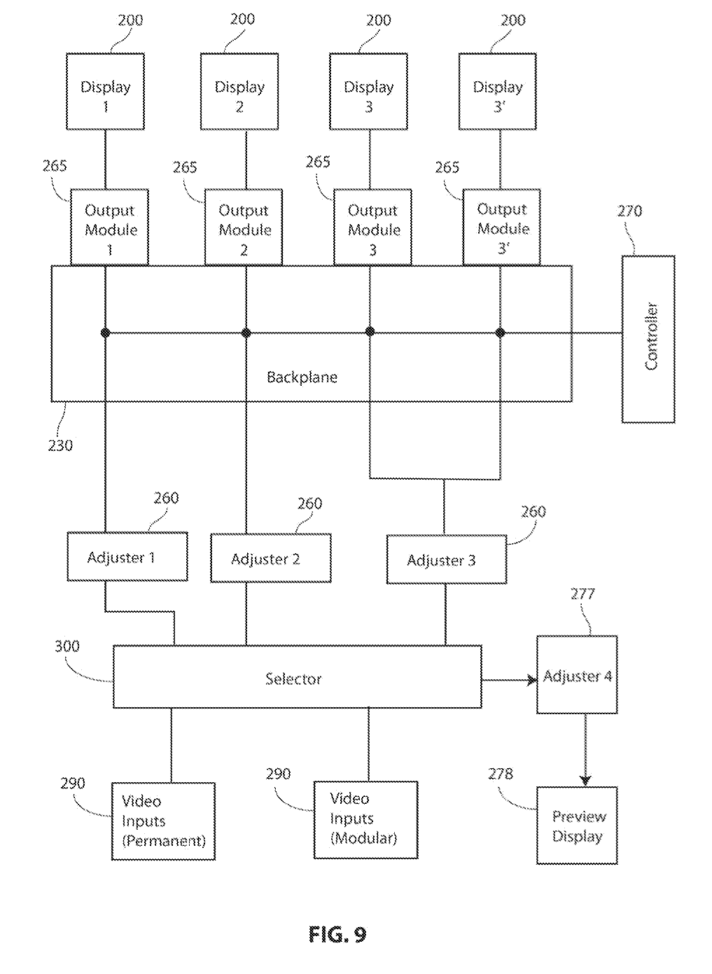

The input and output connectors may be modular/replaceable. In an example embodiment, up to four modular outputs (DVI/Fiber or SDI) can be populated. Because a fourth output module data (Output Module 3′ in FIG. 9) is duplication of the third module data (Output Module 3 in FIG. 9), the fourth output module may be installed the same type as the third module. A DVI-to-fiber adapter can be installed to transmit DVI signal over the fiber optical cable.

The following interfaces may be provided for system control and operation: a RJ (Registered Jack) 11 connector for remote monitor control, a RS-232 on each output video interface card and a DB-9/RS232 connector for command interface and video stream subsystem firmware update. A Mini-A USB connector used for scalar subsystem firmware update only and a type-A USB connector for attaching to the Video Streaming Subsystem may be provided. The type-A USB can be used for file I/O. Also, Ethernet two-port RJ-45 may be used for streaming input and output. Other video, image, audio inputs and outputs may be included in the video connectivity device.

FIG. 8 shows a general diagram of the video connectivity device 10 coupled to a remote interface 205 and three displays 200. The video connectivity device 10 may be coupled to two displays or more than 3 displays. The video connectivity device includes a controller 270 and a normalizer 250, wherein the normalizer 250 is coupled to backplane/output component. The video connectivity device 10 may be coupled to a display 200 with a fiber optic cable. The output supplied by the fiber optic cable has a similar resolution for each display 200 attributable to the controller/normalizer functionality. The controller 270 has a front interface 280 for user selection of a modality and thus allowing a user to input commands for controlling operation of the video connectivity device 10. The normalizer 250 has an input interface 290 for interconnection of signaling from the modalities. The remote interface 205 and front interface 280 may be in the form of front panel buttons or a user interface (i.e., touch screen interface) coupled to the video connectivity device 10.

The input interface 290 of the video connectivity device 10 may include a DVI input, HD-SDI Loop-back in, HD-SDI Loop-back out, HD-SDI Input (Ch. 2), HD-SDI Input (Ch. 1), RGB/YPbPr/VGA, HD-YPbPr/YPbPr, VGA input, Sync-On-Green, S-Video input, Composite Video input as well as S-video output, Ethernet stream output, VGA output and Fiber Optic Output. Other video, image, audio inputs and outputs may be included in the video connectivity device.

FIG. 9 illustrates exemplary components of the video connectivity device. Adjuster 1, adjuster 2, adjuster 3, adjuster 4 and selector 300 may be part of the normalizer 250. The video connectivity device 10 comprises video inputs which may be permanent or modular/replaceable. The video inputs 290 send input signals of graphics, image, video, audio or data and deliver the input signals to selector 300 which may be a switch. The selector 300 receives the input signals and delivers the input signals to an adjuster (adjuster 1, adjuster 2, adjuster 3, adjuster 4) in accordance to the display 1, 2, 3 and 3′ which is selected to display the input data. The selector 300 may be configured to receive eight inputs and to sends six outputs. The adjuster 260 receives the signals and transmits them to a backplane connecting to a controller 270. The controller 270 controls the functionality of the signals and delivers them through the backplane to the output modules 1, 2, 3 and 3′. The signals are then transmitted through the output module 1, 2, 3, and 3′ to the display selected.

A user may input that they wish to preview an image, graphic, video, audio or data. The input may be sent by the controller 270 to the adjuster 277. The selector 300 may receive the input signal and transmit the signal to adjuster 4. The adjuster 4 may then adjust the signal to a preview display 278.

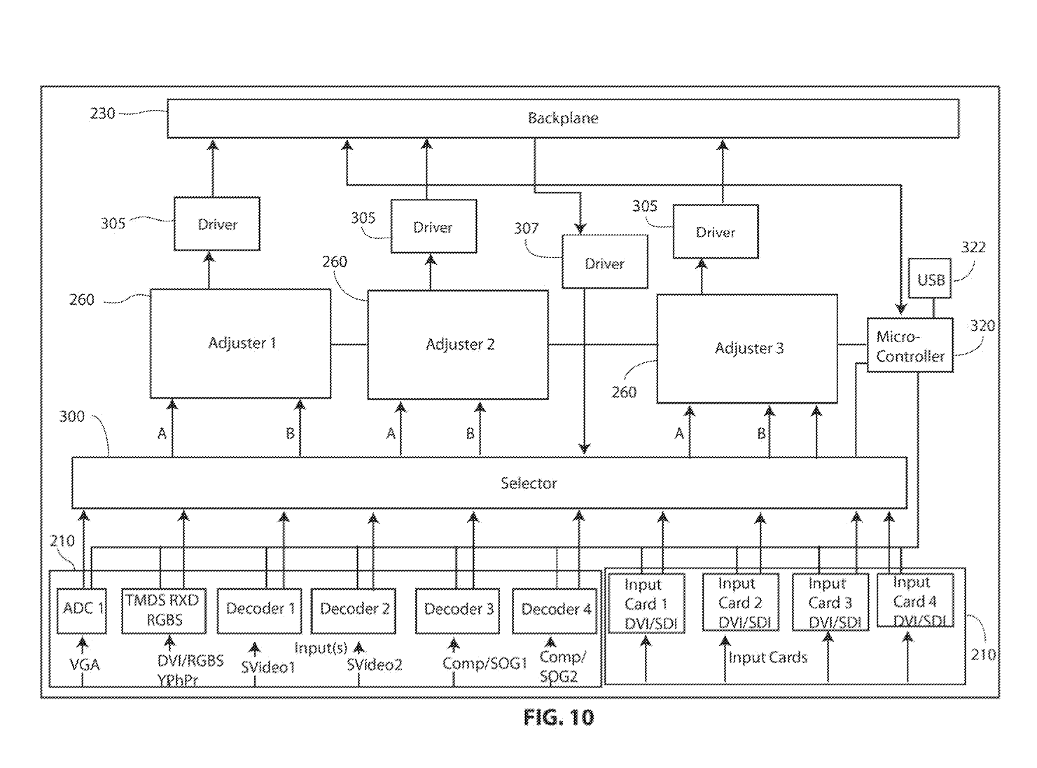

FIG. 10 illustrates one example of a normalizer 250. In FIG. 10, the arrows indicate the direction of the signaling to and from various components in the normalizer 250. The normalizer 250 provides video scaling and switching functionality. The normalizer 250 includes the selector 300 which may be a matrix cross switch (e.g., FPGA) to route input video. The normalizer 250 further includes the adjuster 260 (e.g., video processor (VXP)) to scale, synchronize, spatialize, combine, rotate, and otherwise adjust the input video for display or streaming out. The input signals may be transmitted from modular or permanent input devices/interfaces 210.

The normalizer 250 also converts the modular inputs (e.g., DVI/SDI) into one type of format (i.e., standardized modular bus format). Some standardized modular bus formats are: LVDS Low-voltage differential signaling (LVDS), Transition Minimized Differential Signaling (TMDS) and CMOS (Complementary metal-oxide-semiconductor) parallel 24-bit and parallel 30-bit. A unique identifier may be used to identify the modular plug in type. The identifier differentiates the input format type and aids in the conversion to a particular format.

The input to the selector 300 may be of any number. The same signal may be sent from the modular inputs into all three adjusters 260. The input interface 210 are the following: 2 S-video, 2 Composite/SOG, 1 VGA, 1 YPbPr/DVI/RGBS, and 4 modular inputs (DVI/SDI input cards).

In FIG. 10, the selector 300 may be any type of standard cross switch such as a matrix cross switch. The selector 300 connects to adjuster 1, adjuster 2 and adjuster 3. The adjusters 260 may be video processors. Three video processors may be connected to the selector 300. Each video processor can have a primary (e.g., shown as A) and a secondary image (e.g., shown as B) to be displayed in various dual or multiple-image (e.g., Picture-in-Picture (PIP) or side-by-side) configurations. All the B signaling maybe wired together if a common secondary image may be transmitted. A microcontroller 320 (e.g., Renesas) is used to detect video input mode and to set up the video connectivity device configuration. Drivers 305 and 307 such as Transmission minimized differential signaling (TMDS) or Low-voltage differential signaling (LVDS) may be used to encode information transmitted to a backplane connector.

Memory such as USB 322 may be used to store graphics, video, images, data and audio. Data, images, video and graphics from ethernet connection may be sent to the selector 300. The selector 300 may then transmit this data to the adjuster(s) 260.

The adjusters 260 comprises a temporal combiner for synchronous or asynchronous combining of received signals, a spatial combiner for placement of graphics, image, video or data; and a scaler for geometric scaling or non-geometric scaling and rotation of graphics, video, image or data. The temporal combiner combines received synchronous and asynchronous signals of graphics, image, video, audio or and data. The graphics, image, video, audio or and data may then be synchronize for transmission simultaneously or in a particular pattern. The temporal combining may occur in near real time or real time. The spatial combiner places input signals together for proper configuration of graphics, image, video or data. The scaler scales the graphics, image, video or and data for geometric scaling, non-geometric scaling. Geometric and non-geometric scaling enlarges or decreases the size of the graphics, image, video or data. The adjuster also rotates graphics, image, video and data for proper configuration on the display 1.

The normalizer 250 may have the following external connectors: DVI in, VGA in (HD15), RGBS in (HD15), 2-S-VIDEO, 2-Composite/SOG (BNC), 2-SDI in (BNC-hi freq), SDI out (BNC-hi freq) and RJ11-6 pin. The normalizer may have the following internal connectors: backplane connector, 10 pin keypad (for testing) and 4-pin power connector (for testing). Other features of the normalizer 250 may include a VGA, DVI/RGBS, S-Video/Comp-1, S-Video/Comp-2 inputs as built-in connectors. The normalizer 250 can support up to four modular inputs, either DVI or SDI type. The normalizer 250 can also receive International Telecommunication Union (ITU) ITU-1120 signals from the (encoder-decoder (codec) 362 and 361 blocks on the controller board.

The selector (i.e., FPGA configured as a matrix switch) 300 routes selected inputs to three adjustors (e.g., VXP) 260. Each VXP can have one primary and one secondary graphics, image, video or data source. In addition, the matrix FPGA may performs gamma correction on input signals. The normalizer 250 may transfer full 30-bit data-out to the backplane via LVDS or TMDS signaling to be used by Video Transfer Card (i.e., SDI, DVI and Fiber) or the Codec 360 and 361 Block. For a DVI Output Video Card, the video processor (e.g., VXP) output resolution can be programmed to either 1920×1080 or 1920×1200. For a SDI Output Video Card, the video processor (e.g., VXP) output resolution can be programmed to either 1920×1080i or 1920×1080p.

Functions of the microcontroller 320 are to configure and control and include the following: 1) Input devices: Analog to Digital Converter (ADCs), decoders, etc and modular input card type detection via I2C, 2) Output devices: (Digital to Analog Converter Digital Video Interface (DAC DVI), SDI transmitters and modular output card type detection I2C, 3) FPGA mux control and gamma table setup via SPI, 4) User commands from serial port. Non-volatile random access memory (NVRAM) is provided for storing normalizer settings. The setting data includes Pictures Settings, System, and User Defaults.

In FIG. 10, the microcontroller 320 (i.e. Renesas) communicates with the adjusters 260 (e.g., video processors) through System Packet Interface (SPI). Request for data are daisy chained through the three video processors (e.g., VXPs). Only one video processor (e.g., VXP) can be reached (read/write) at any given time depending on its chip select state. To send commands to a video processor (e.g., VXP) from Renesas, first it may enable the Chip Select (CS) signal of the target video processor (e.g. VXP). After that, it can send requests to the video processor (e.g. VXP). CS may be set first before reading any response from the VXP. The normalizer 250 may include other components for receipt and delivery in the video connectivity device 10.

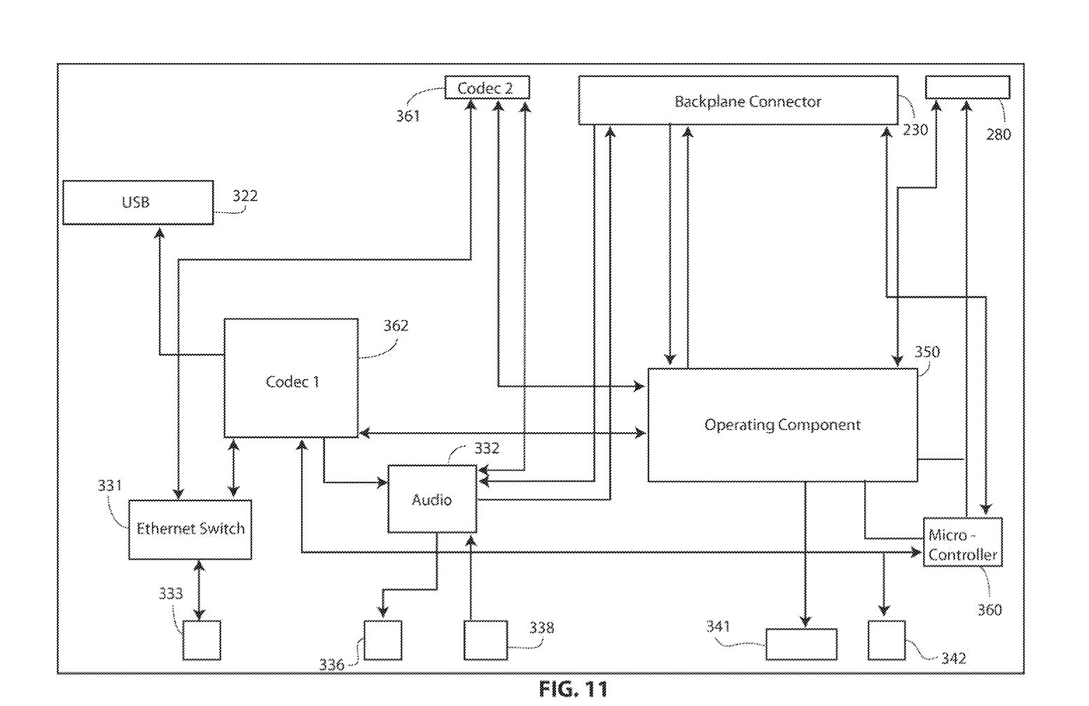

FIG. 11 illustrates one example of a controller 270. In FIG. 11, the arrows indicate the direction of signaling to and from various components in the controller.

The controller 270 determines which input channel signal is to be transmitted to the backplane connector or the normalizer 250. The controller 220 is configured to send and receive data from the normalizer 250. The controller 270 includes an operating component 350 such (e.g., FPGA) configured to transmit information processed in the controller and to receive information for processing in the controller. Data configured according to ITU601 and ITU 656 may come into and out of the controller 270. The controller 270 comprises an interlacer (and a de-interlacer) for interlacing (and de-interlacing) video, graphics, image and data.

In particular, the controller 270 comprises the video connectivity device's external control interfaces such as RS232 342, USB 322, and LCD connection to front interface 280 via the backplane connector 230. The controller may have the following external connectors: I-USB, 2 Ethernet Hub, 1 each Audio in and out, MIC in, 1 SPDIF digital audio out, 1 SPDIF Fiber audio out, 1 RS232 in with one Re-derive, 1-Power connectors for external monitor, 1-Analog output YPbPr connectors from Codec 362 and 361 and 1—DVI-D output connector for recording and 1-24V input power connector. The controller may have the following internal connectors: front LCD power and RS232 connector, 10 key front keypad (optional), dual USB connector for internal device, single USB connector for internal devices, Backplane connector, AT Attachment (ATA, a data transfer interface standard) connector for Internal Hard Drive, Mini PCI connector for future use, and 5V connector for FAN.

For remote video connectivity, data can be sent from the ethernet port 333 (i.e., RJ45) to the Ethernet switch 331 and then to codec 1 360 and codec 2 361.

USB 322 connectivity to the hard drive is also available through the controller 270. Using the USB connectivity, video and files may be delivered to the display through the controller 270 and then may be sent to the normalizer 250. The Codec 361 and 362 may be used as the intelligence for the USB connection.

Audio in 337 and Audio out 338 streaming data may be sent to the audio port 332 and then to codec 362 for processing.

The operating component 350 may be used to deliver signals using port 341 to preview display 278.

The operating component 350 also provides connection to DVI and HD components through 24 bit RGB Recording and 24 bit YUV lines.

A microcontroller 360 controls the controller 250 and communicates via RS 232 interface 342 to a touch screen. The microcontroller also communicates to front interface 280. The operating component 350 also includes a video processor (i.e., VXP) in communication with the microcontroller 260. This allows video functionality to be displayed on a front screen interface of the video connectivity device. Another RS232 connection 342 is provided in the controller for delivering commands from a PC or another machine.

Some of the detailed functions of the controller are as follows. The operating component 350 may be a microchip/FPGA, matrix cross switch. A microchip/FPGA may be used to control up to 8 hardware serial ports (4 monitors, 1 touch panel, 1 external serial port, and 2 Codec 362 and 361) with buffering capability. A matrix cross switch (e.g., FPGA) may convert to signal from video processor (e.g., VXP) of 1080P and feed to Codec 362 and 361 1080i (ITU 601 to ITU 656 conversion and interlacing). The matrix cross switch (i.e., FPGA) routes Codec 362 and 361 video output as a 1080i YPbPr input to normalizer. The matrix cross switch (e.g., FPGA) also routes Codec 362 and 361 video output 1080i to DAC, which converts to YPbPr, for direct display and/or DVI for recording. A streaming capability is based on Codec 362 and 361, which are capable of streaming out up to 1080i 30 fps. The optional second codec 351 can be configured to allow concurrent streaming in and out. Optional VXP can be added to drive touchscreen directly and provide live video preview functionality. Battery backed Real time clock is attached to Microchip. Date and Time can be set through serial port using NDS serial commands. The Codec 362 and 361 system needs to sync its own date/time from the microcontroller.

Data from the matrix cross switch is transmitted to the Codec 362 and 361 block for encoding data. On the other hand, data is decoded in the Codec 362 and 361 Block for transmittal to the matrix cross switch. The Codec 362 and 361 Block also converts video information into a format that is suitable for transmittal through the Ethernet. In particular, the controller comprises a Codec 362 and 361 Block that can stream in and out compressed video stream through the Ethernet interface on the Codec 362 and 361 Block. The Codec 362 and 361 Block also separates the video from the audio.

The Codec 362 and 361 Block provides HD video streaming functionality. The Codec 360 and 361 Block also provides video streaming capability. The Codec 362 and 361 Block operates in either server mode (sending compressed video data out through Ethernet) or client mode (receives compressed video packets from Ethernet, uncompresses the data and sends the data out to the video output port in YUV format. The Codec 362 and 361 Block is capable of encoding and decoding audio input. The Codec 362 and 361 Block subsystem is controlled through RS232 interface. Commands can be sent to setup the system configuration and start/stop streaming operations. A RS232 Header via Universal Asynchronous Receiver Transmitter (UART) 1 may be provided for debugging purpose.

The controller may comprise an internal backplane having following signals: RS232 to adjustor, RS232 to output boards, Reset to adjustor, 16 bit data, syncs, and clock from Codec 362 and 361 Block to VXP, 24 bit data, syncs, and clock from VXP to Codec 362 and 361 Block and +24V power and Ground. The controller may include optional external connectors.

The controller may include other components for receipt and delivery in the video connectivity device.

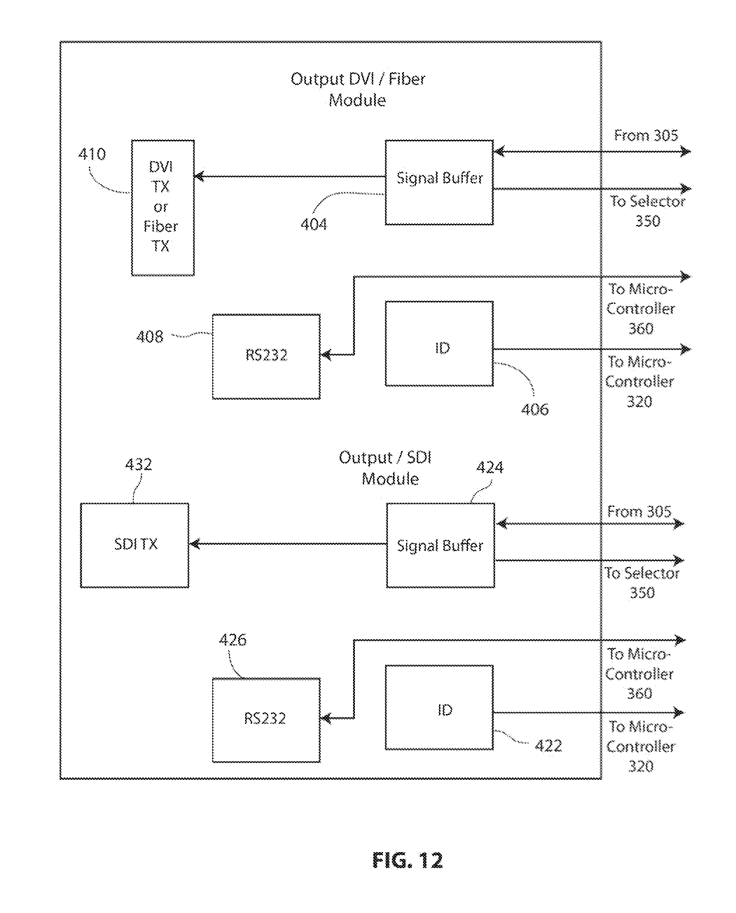

FIG. 12 illustrates examples of output modules. In FIG. 12, the arrows indicate the direction of signaling to and from various components. The signal buffer 404 and 424 receives video from drivers 305 and 307. The signals from the buffer 404 are then sent to a DVI or Fiber transmitter 410. The signals from the buffer 424 are then sent to a SDI transmitter 432. The signals from the signal buffer 404 and 424 may be sent to the selector 350 for preview display.

Signals may be sent back and forth from/to the microcontroller 360 to RS232 connection 408 and 426. An identification chip 406 and 422 may be connected to the microcontroller 320.

In FIG. 12, modular output functionality is achieved through Video Transfer Card (VTC) connection. Each card can be either DVI or SDI type. Fiber optic connector can be used for transmission of DVI signal over fiber optical cable. Output from modules may be cloned and divided into 2 modules, resulting in 4 output modules.

FIG. 12 comprises the identification chip 422 for identifying the format of inputs (i.e., DVI or SDI). The identification chip 422 is connected to the VTC. The output modules connect to the backplane through the VTC connection.

The output data is transmitted to the display for the user to view. The user may enter input into the display. If the user enters input through the display, the input data may be transmitted to the video connectivity device using a RS 232 connection 408 and 426. The output modules may connect to a display via a fiber adaptor or a wireless transmitter.

The video connectivity device may include other components and signaling methods for output including but not limited to optical, infrared radiation (IR), radio-frequency and wireless.

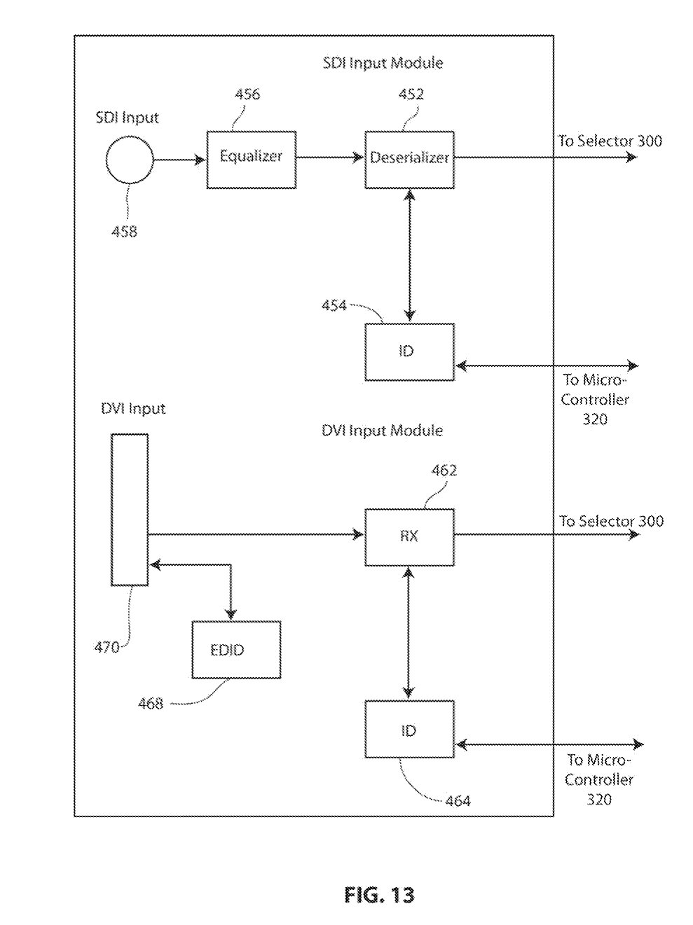

FIG. 13 illustrates examples of input modules. In FIG. 13, the arrows indicate the direction of signaling to and from various components.

For example, an SDI input module 458 may send signaling to an equalizer 456 and then to deserializer 452. The deserializer 452 then transmits signal to selector 300. An identification chip 454 may be used for identifying the format of inputs which may be controlled by microcontroller 320.

A DVI input module 470 may send signaling to a receiver 462 and then to a selector 300. An EDID memory system 468 is coupled to the DVI module 470. An identification chip 464 may be used for identifying the format of inputs which may be controlled by microcontroller 320.

In addition to a set of built-in input video connectors, up to 4 modular input cards can be installed. They can be either SDI or DVI type. To identify the type information, an on-board PIC microcontroller is connected to Renesas on the normalize 250 via I2C bus. The microcontroller 320 can accept a type query command from the Renesas and responds with type information.

The video connectivity device 10 may include other components and signaling methods for input including but not limited to optical, infrared radiation (IR), radio-frequency and wireless.

Moreover, a backplane board 230 provides inter-connection between normalize 250, controller and video transfer card (VTC). In addition, the backplane distributes power to the entire system. The back plane is comprised of 3 rows of connectors for connecting the adjustors to Video Transfer Card (VTC) and controller. The backplane 230 may be physically folded and configured to connect to a circuit board. The backplane 230 allows signals to be transmitted from one level to another. The back plane 230 receives data from the normalizer and delivers it to the output modules or the controller. The back plane may include other components for receipt and delivery in the video connectivity device.

Input selection may occur through a touch screen via a front interface 70/280 and remote interface 55/205. The touch screen interface allows user to set up switching matrix, streaming input and output configuration. The main screen is the power-up screen. Touch-screen displays four options for the user to choose from: select inputs, information, IP Streaming and output Settings. The inputs may be a primary and secondary input. The screens may show output module configuration. If an output slot is empty, the corresponding row will be disabled. The output type, SDI or DVI, is automatically detected. For a DVI module, VXP output resolution can be programmed to either 1920×1080 or 1920×1200. For a SDI Output module, VXP output resolution can be programmed to either 1920×1080i or 1920×1080p. The video connectivity device can be configured either as a stream sender (stream out) or receiver (stream in).

In particular, the user may select the display for which he/she will select primary and secondary inputs. The interface displays the current primary and secondary input selected for that display and allows user to change those settings by pressing a ‘Change’ button. An identify button, when pressed will send a message to the connected displays to overlay a number ‘1’ to ‘3’ depending on which output of the connectivity device 10 they are connected to. A Picture-in-picture, PIP+ button, increases the PIP size for the selected display. A PIP-button decreases the PIP size for the connected display. A swap button swaps the primary and secondary inputs for the connected display. A Disable PIP button will disable PIP for the selected display.

Other means of input selection may be utilized through the video connectivity device.

As mentioned earlier, audio may be streamed though the video connectivity device 10. Audio may be delivered through the video connectivity device 10 using MIC In or LINE In. Audio may be transmitted to a display or to a microphone system. The format of the audio may be converted through the video connectivity device 10. The controller 270 may receive audio data from the monitor and may deliver audio to the VTC. A Codec 360 and 361 Block may be used to separate the audio and video data.

Audio data may also be received via the Ethernet connection and transmitted to another machine via the Ethernet connection.

The audio data does not have to go through the normalizer 250. Two stereo audio inputs may be supported such as 3.5 mm standard stereo microphone input and 3.5 mm standard stereo line in. Three audio outputs may be supported such as 3.5 mm standard stereo headphone out, 3.5 mm standard stereo line out and Optical transmitter for SPDIF.

Other means to stream audio may be utilized through the video connectivity device.

Generally, the operation of the video connectivity device 10 may involve the following steps. A user sets the display's resolution. As an example, for SDI output, the user may choose either 1920×1080i or 1920×1080p resolution. As another example, for DVI output, the user may choose either 1920×1080 or 1920×1200 resolution. For each display, a user may select the primary and secondary inputs. If the video connectivity device is used as video server, an output as stream source is specified. A user may set the streaming resolution. Since the maximum resolution for video output streamed out is 1920×1080, it will be down scaled to this resolution if it was set to 1920×1200. If the video connectivity device is used as video receiver, a user may enter the remote video server IP and select a display for viewing. The decoded video is presented as an YPbPr input and is then processed by the video connectivity device to be displayed.

Additionally, for example, multiple video connectivity devices may be controlled by a serial connection (i.e., RS-232 connection). In all the embodiments, the signals maybe be encoded or error correction system/codes may be placed in the video connectivity device.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A clinical connectivity device coupled to a display comprising:
a user interface configured to select a display format;
a controller configured to receive commands from the user interface and for controlling operation of the clinical connectivity device;
more than one selector coupled to the controller and an adjuster, the selector configured to receive input signals of graphics, image, video, audio or data from devices in a clinical setting and is further configured to select a signal to be transmitted to the adjuster based on input signal format; and
the adjuster coupled to the controller and the display for matching a received signal format to the display format, the adjuster comprising:
a temporal combiner configured to combine synchronous and asynchronous received signals;
a spatial combiner configured to place graphics, image, video or data;
a scaler for geometric scaling and non-geometric scaling of graphics, image, video or data; and
a rotation component configured to rotate graphics, image, video or data.

2. The clinical connectivity device of claim 1, further comprising an analog to digital converter.

3. The clinical connectivity device of claim 1, further comprising a digital format converter.

4. The clinical connectivity device of claim 1, further comprising an 8-bit converter.

5. The clinical connectivity device of claim 1, further comprising a buffer.

6. The clinical connectivity device of claim 1, wherein the adjuster is a video processor.

7. The clinical connectivity device of claim 1, further comprising a transition minimized differential signaling driver.

8. The clinical connectivity device of claim 1, further comprising a low-voltage differential signaling driver.

9. The clinical connectivity device of claim 1, wherein the input signals and output signals are Digital Video Interface (DVI) signal, Serial Digital Interface (SDI signal), RS232 signal, Red Green Blue Composite Sync (RGBS) signal, Luma-Chroma (YPbPr) signal, S-Video signal, optical connection signal, audio signal, Sony/Philips Digital Interconnect Format (SPDIF) signal, Ethernet connection signal, USB connection signal, VGA connection signal, Composite signal, or Sync-on-Green (SOG) signal.

10. The clinical connectivity device of claim 1, further comprising a memory coupled to the adjuster.

11. The clinical connectivity device of claim 1, wherein the user interface is a touch screen interface or front panel buttons.

12. The clinical connectivity device of claim 1, wherein one of the selectors is configured to select a signal based on a Red-Green-Blue (RGB) format.

13. The clinical connectivity device of claim 1, wherein one of the selectors is configured to select a signal based on a Luma-Chroma (YUV) format.

14. The clinical connectivity device of claim 1, wherein one of the selectors is configured to select a signal based on a type of device in the clinical setting.

15. A clinical connectivity device coupled to a display comprising:
a user interface configured to select a display format;
a controller configured to receive commands from the user interface and for controlling operation of the clinical connectivity device;
a selector coupled to the controller and more than one adjuster, the selector configured to receive input signals of graphics, image, video, audio or data from devices in a clinical setting and is further configured to select any input signal to be transmitted to one or more adjusters based on an input signal format; and
the adjusters coupled to the controller and the display for matching a received signal format to the display format, the adjuster comprising:
a temporal combiner configured to combine synchronous and asynchronous received signals;
a spatial combiner configured to place graphics, image, video or data;
a scaler for geometric scaling and non-geometric scaling of graphics, image, video or data; and
a rotation component configured to rotate graphics, images, video or data.

16. The clinical connectivity device of claim 15, wherein the selector is a cross switch.

17. The clinical connectivity device of claim 16, wherein the selector is a matrix cross switch.

18. The clinical connectivity device of claim 15, wherein the adjuster is configured to receive one primary input signal and one secondary input signal.

19. The clinical connectivity device of claim 15, wherein the controller comprises:
an operating component configured to send and receive signals from an output module, a microcontroller and an encoder-decoder (codec);
wherein the operating component is configured to select, mix, interlace, convert and process signals;
wherein the codec is configured to encode and decode signals;
wherein the microcontroller is coupled to the codec and operating component and is configured to receive commands from the user interface and to receive signals from the output module and is also configured to control the controller.

20. The clinical connectivity device of claim 19, wherein the controller further comprises an audio component coupled to the codec and an output module, the audio component configured to receive and send audio signals.

21. The clinical connectivity device of claim 19, wherein the controller further comprises a universal standard bus (USB) coupled to the codec configured to store graphics, image, video, audio or data.

22. The clinical connectivity device of claim 19, wherein the controller further comprises an ethernet component coupled to the codec configured to transmit and receive graphics, image, video, audio or data.

23. The clinical connectivity device of claim 15, further comprising an output module having a video transfer card, an identification chip, and a transmitter.

24. The clinical connectivity device of claim 15, further comprising an input module having a receiver and an identification chip.

25. The clinical connectivity device of claim 15, wherein one of the adjusters is a preview adjuster.

26. The clinical connectivity device of claim 15, further comprising an analog to digital converter.

27. The clinical connectivity device of claim 15, further comprising a digital format converter.

28. The clinical connectivity device of claim 15, further comprising a buffer.

29. The clinical connectivity device of claim 15, wherein the adjusters are video processors.

30. The clinical connectivity device of claim 15, further comprising a transition minimized differential signaling driver.

31. The clinical connectivity device of claim 15, further comprising a low-voltage differential signaling driver.

32. The clinical connectivity device of claim 15, wherein the input and output signals are Digital Video Interface (DVI) signal, Serial Digital Interface (SDI signal), RS232 signal, Red Green Blue Composite Sync (RGBS) signal, Luma-Chroma (YPbPr) signal, S-Video signal, optical connection signal, audio signal, Sony/Philips Digital Interconnect Format (SPDIF) signal, Ethernet connection signal, USB connection signal, VGA connection signal, Composite signal, or Sync-on-Green (SOG) signal.

33. The clinical connectivity device of claim 15, wherein the user interface is a touch screen interface or front panel buttons.

34. The clinical connectivity device of claim 15, wherein the selector is configured to select a signal based on a Red, Green, Blue (RGB) format.

35. The clinical connectivity device of claim 15, wherein the selector is configured to select a signal based on a Luma-Chroma (YUV) format.

36. The clinical connectivity device of claim 15, wherein the selector is configured to select a signal based on a type of device in the clinical setting.

37. A method of displaying graphics, image, video or data on a display and for receiving audio signals from one or more clinical devices in a clinical setting comprising:
setting a display format;
receiving input signals of graphics, image, video, audio or data from devices in a clinical setting and selecting a selector based on an input signal format;
transmitting input signals to an adjuster to match the display format;
adjusting the transmitted signals and sending the adjusted signals to a display in near real-time, wherein the step of adjusting comprises:
temporally combining received signals synchronously and asynchronously;
spatially placing graphics, image, video or data signals on the display;
scaling graphics, image, video or data signals geometrically and non-geometrically; and
rotating graphics, image or video signals.

38. The method of claim 37, further comprising converting the input signals to digital signals.

39. The method of claim 37, further comprising converting the input signals into one color format signal.

40. The method of claim 37, further comprising:
providing a command with an address to set the display format;
determining whether the command matches a device in the clinical setting; and
transmitting the input signal to a selector if the address matches the device in the clinical setting.

41. The method of claim 37, further comprising encoding the adjusted signal for sending to a display.

42. The method of claim 37, further comprising selecting a selector based on a Red, Green, Blue (RGB) format.

43. The method of claim 37, further comprising selecting a selector based on a Luma-Chroma (YUV) format.

44. The method of claim 37, further comprising sending signals to or from a device in the clinical setting through electrical signals, optical signals, wireless signals, radio frequency and infrared radiation (IR).

45. A method of displaying graphics, image, video or data on a display and for receiving audio signals from one or more clinical devices in a clinical setting comprising:
setting a display format;
receiving input signals of graphics, image, video, audio or data from devices in a clinical setting;
transmitting the input signals to any one of adjusters to match the display format;
adjusting the transmitted signals and sending the adjusted signals to a display in near real-time, wherein the step of adjusting comprises:
temporally combining the signals synchronously and asynchronously;
spatially placing graphics, image, video or data signals on the display;
scaling graphics, image, video or data signals geometrically and non-geometrically; and
rotating graphics, image or video signals.

46. The method of claim 45, further comprising previewing the input signals on a preview display.

47. The method of claim 45, further comprising converting the input signals to digital signals.

48. The method of claim 45, further comprising converting the input signals into one format.

49. The method of claim 45, further comprising:
providing a command with an address to set the display format;
determining whether the command matches a device in the clinical setting; and
transmitting the input signal to a selector if the address matches the device in the clinical setting.

50. The method of claim 45, further comprising routing a primary and a secondary input signal.

51. The method of claim 45, further comprising encoding the adjusted signal for sending to the display.

52. The method of claim 45, further comprising sending and receiving signals of graphics, image, video, audio or data from an ethernet port.

53. The method of claim 45, further comprising sending and receiving audio signals from an audio line.

54. The method of claim 45, further comprising encoding and decoding the input signals.

55. The method of claim 45, further comprising delivering commands from a personal computer (PC) or another machine.

56. The method of claim 45, further comprising selecting, mixing, interlacing, converting and processing signals.

57. The method of claim 45, further comprising receiving signals from an output module.

58. The method of claim 45, further comprising storing the input signals of graphics, image, video, audio or data.

59. The method of claim 45, further comprising sending signals to or from a device in the clinical setting through electrical signals, optical signals, wireless signals, radio frequency and infrared radiation (IR).
